(19) United States
(12) Patent Application Publication
(10) Pub. No.: US 2005/0067532 A1
(43) Pub. Date: Mar. 31, 2005

(54) Radar absorbing electrothermal de-icer

(76) Inventors: James T. Hindel, Tallmadge, OH (US); David L. Brittingham, Canton, OH (US); Dean A. Burner, N. Canton, OH (US); James C. Putt, Doylestown, OH (US); Richard J. Cole, Stow, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/947,671

(22) Filed: Sep. 23, 2004

Related U.S. Application Data
(60) Provisional application No. 60/506,126, filed on Sep. 25, 2003.

(51) Int. Cl. B64C 27/22

(52) U.S. Cl. 244/134 D

(57) ABSTRACT

Radar absorbing electrothermal deicing apparatus for use in deicing an airfoil surface comprises: a heater element including a predetermined area pattern of conductive metallic material; and a layer of radar absorbing material disposed over the heater element. In addition, a method of absorbing radar signals in an electrothermal deicer comprises the steps of: disposing an electrothermal deicing element at a surface of an airfoil; and disposing a layer of dielectric material comprising a filler of magnetic material over the electrothermal deicing element.

This utility application claims the benefit of the filing date of U.S. Provisional Application No. 60/506,126, filed Sep. 25, 2003.

### BACKGROUND OF THE INVENTION

The present invention is related to electrothermal deicing systems, in general, and more particularly, to electrothermal deicing apparatus having radar absorbing characteristics.

Electrothermal deicing apparatus is applied generally to the airfoils of aircraft to protect the surfaces thereof from accumulating ice that may disturb the airfoil aerodynamics or that may be dislodged from the surface and become a potential foreign object damage (FOD), especially in the case of the aircraft engines. Generally, electrothermal deicing apparatus as shown in the cross-sectional airfoil illustration of FIG. 1 comprises a layer of electrically conductive circuits 10 which may be configured as metal foils, wires, conductive fabrics and the like, for example, disposed in a pattern over a surface 12 of an airfoil 14. A deicing system 20 controls the voltage and current to the electrical circuits of layer 10 via a plurality of leads 16 to protect the airfoil surface 12 from accumulating ice. However, the metallic/conductive nature of the layer 10 renders present electrothermal deicing apparatus impractical to be used on aircraft where radar attenuation is of concern.

The present invention overcomes this drawback of the present electrothermal deicing apparatus and permits application of the conductive layer 10 on surfaces requiring both radar attenuation and protection from ice.

### SUMMARY OF THE INVENTION

In accordance with one aspect of the present invention, radar absorbing electrothermal deicing apparatus for use in deicing an airfoil surface comprises: a heater element including a predetermined area pattern of conductive metallic material; and a layer of radar absorbing material disposed over the heater element.

In accordance with another aspect of the present invention, a method of absorbing radar signals in an electrothermal deicer comprises the steps of: disposing an electrothermal deicing element at a surface of an airfoil; and disposing a layer of dielectric material comprising a filler of magnetic material over the electrothermal deicing element.

### BRIEF DESCRIPTION OF THE DRAWINGS

FIG. 1 is a cross-sectional illustration of a portion of an aircraft airfoil on which electrothermal deicing apparatus is applied.

FIG. 2 is a cross-sectional illustration of electrothermal deicing apparatus suitable for embodying the principles of the present invention.

FIG. 3 is an exemplary area pattern for an electrothermal heater element suitable for use in the electrothermal deicing apparatus of FIG. 2.

FIG. 4 is a graph of radar cross sectional area data in accordance with the present embodiment.

### DETAILED DESCRIPTION OF THE INVENTION

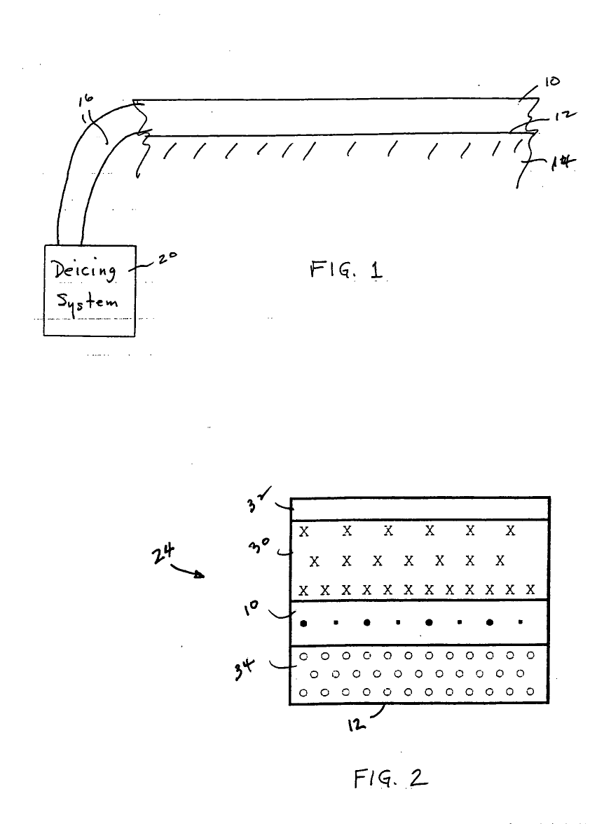

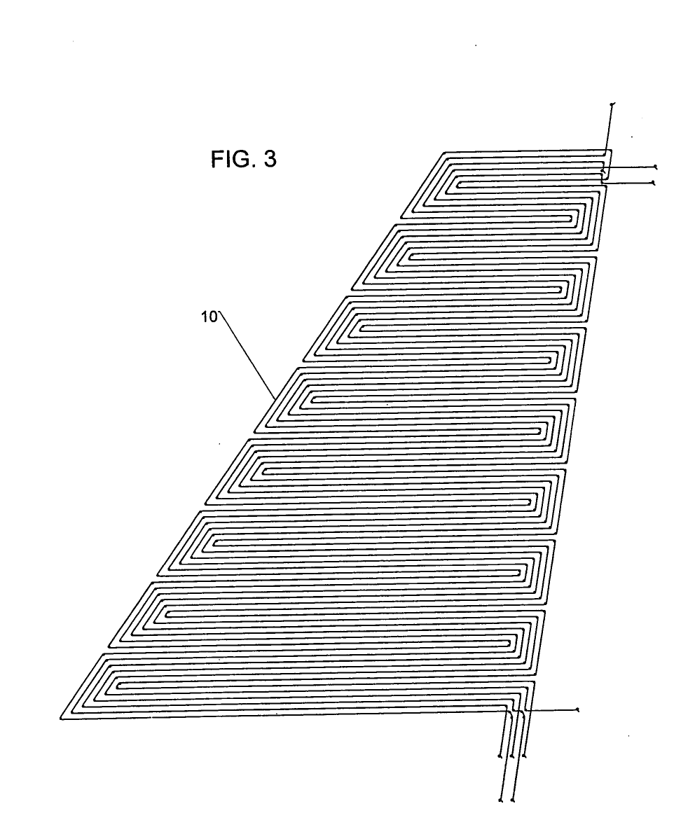

FIG. 2 is a cross-sectional illustration of an exemplary embodiment of electrothermal deicing apparatus 24 suitable for use on the airfoil surface 12 of FIG. 1. In the present embodiment, the electrical circuits of layer 10 are combined with one or more layers of radar absorbing materials (RAM) and together disposed in a layered prepreg or other such composite material using composite manufacturing techniques such as resin transfer molding, for example, to form a radar absorbing structure (RAS). The electrical circuits of layer 10 have a predetermined area pattern which will work well as a heating element for surface 12 within most resin systems, like epoxy and bis-moly imide (BMI), for example, depending on the temperature specifications.

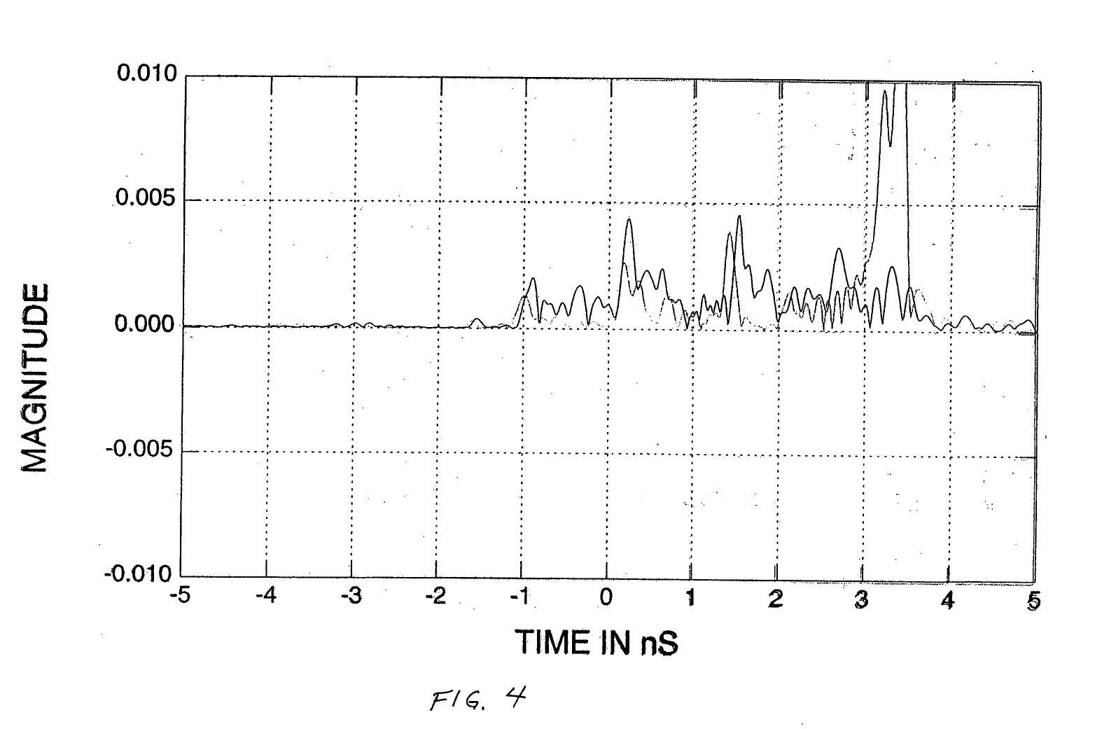

An exemplary area pattern for the heating element 12 is shown in the embodiment of FIG. 3 which comprises wire runs in open ended, rectangular shaped patterns one within the other. The wire is conductive metallic which may be copper, stainless steel or an alloy of stainless steel, for example, and may be only a few mils in diameter. The wire may be coated with an insulating layer approximately a few mils thick. Electrical energy may be applied to the ends of wire runs to apply electrothermal heating for deicing purposes. The area pattern of the heating element 12 may be made small enough to be applied to a vane of an aircraft engine or large enough to span an aircraft wing or portion thereof. The airfoil surface may be made of a metallic material or a composite without deviating from the broad principles of the present invention. If the airfoil is made of a composite material, the radar absorbing, electrothermal deicing apparatus may be disposed within the composite material, preferably at the surface thereof.

Referring back to FIG. 2, one or more layers of RAM 30 are disposed over the electrical circuit layer 10. In the present embodiment, the RAM layer 30 may be comprised of a dielectric material, like ethyl acrylic or a VAMAC™ (a trademark of Dupont) material, for example. For good thermal conduction, the RAM layer 30 should be made as thin as possible, but not so thin that it will defeat the radar absorbing properties thereof. A suitable thickness of a VAMAC™ material for the present embodiment was found to be on the order of 0.037 inches, for example.

The RAM 30 may be tuned to absorb a particular radar frequency or frequency range depending on the specifications of each individual application. This may be accomplished by mixing a filler in the form of a fine powder of a ferrite or magnetic material, like iron carbonyl, for example, into the layer of dielectric material. The absorption tuning according to specification may be effected by the percentage of ferrite filler material mixed into the dielectric material. The mixing of fine powder filler into the dielectric material may occur through a roller milling process, for example, and a resultant desired thickness of the RAM 30 may be controlled through the rolling process.

An outer or erosion protective surface layer 32 may be disposed over the RAM layer 30 depending on the application. In addition, back side insulating plies 34 may be disposed between the electrothermal heater layer 10 and the airfoil surface 12 for electrical and thermal insulation. In some applications, the conductive heater layer of electrical circuits 10 may include dielectric insulating plies 34 on both sides thereof. The dielectric insulating plies 34 may be comprised of plies of glass, Quartz, Kevlar, Graphite and the like, depending on the structural specifications of the electrothermal deicing apparatus.

Moreover, the elemental area pattern of layer 10 may be configured to aid in the ability to attenuate or minimize reflection of radar signaling. Depending on the amount of heat or power densities specified to be generated, the material of the heating element 10 could be considered part of the RAS 24. Accordingly, the heating element layered embodiment 24 described in connection with FIG. 2 is operated by the deicing system 20 to form a radar absorbing electrothermal de-icer for utilization in many different applications.

A series of composite test parts were constructed using variants of the foregoing described technology with different electrothermal heater designs. The parts were tested on a compact radar range over the 2-18 gigahertz frequency spectrum and were rotated at four desired angles on incidence. A focused radar beam was used to determine radar cross sectional area against a standard baseline six inch diameter aluminum sphere in both horizontal and vertical polarizations.

The foregoing described technology was effective in absorbing the radar signal reflected by the electrically conductive electrothermal heater. Different absorptances were achieved when the reflective signal was completely attenuated by such technology. The efficiency of collecting and absorbing by the technology was determined to be tunable by both different combinations of design and materials. FIG. 4 is a graph of radar cross sectional area data taken of a sample of the technology at ten degrees angle of incidence and with vertical polarization. The dark line in the graph represents technology deicer data and the light line represents baseline testing data of the same deicer design.

While the present invention has been described herein above in connection with one or more embodiments, it is understood that such description was merely by way of example. Accordingly, the present invention should not be limited in any way by the described embodiments herein, but rather construed in breadth and broad scope in accordance with the recitation of the claims appended hereto.

1. Radar absorbing electrothermal deicing apparatus for use in deicing an airfoil surface comprising:
a heater element including a predetermined area pattern of conductive metallic material; and
a layer of radar absorbing material disposed over said heater element.

2. The apparatus of claim 1 wherein the heater element includes wire runs in the predetermined pattern.

3. The apparatus of claim 2 wherein the wire runs are configured in open ended, rectangular shaped patterns, one within the other.

4. The apparatus of claim 1 including a deicing system for applying electrical energy to the heater element to effect electrothermal heating for airfoil deicing purposes.

5. The apparatus of claim 1 wherein the layer of radar absorbing material comprises a dielectric material having a magnetic material filler disposed therein.

6. The apparatus of claim 5 wherein the dielectric material comprises an ethyl acrylic material.

7. The apparatus of claim 5 wherein the magnetic filler material is in the form of a fine powder.

8. The apparatus of claim 5 wherein the magnetic filler material is mixed into the dielectric material by a roller milling process to form the layer of radar absorbing material.

9. The apparatus of claim 8 wherein the layer of radar absorbing material is controlled into a desired thickness by the roller milling process.

10. The apparatus of claim 5 wherein the magnetic filler material comprises iron carbonyl.

11. The apparatus of claim 1 including a protective layer disposed over the radar absorbing material layer.

12. The apparatus of claim 1 including an insulating layer disposed under the heater element for electrical and thermal insulation from the airfoil surface.

13. The apparatus of claim 1 wherein the airfoil surface is made of a composite material; and wherein the radar absorbing, electrothermal deicing apparatus is disposed within the airfoil composite material.

14. The apparatus of claim 13 wherein the radar absorbing, electrothermal deicing apparatus is disposed within the airfoil composite material at the outer surface thereof.

15. Method of absorbing radar signals in an electrothermal deicer comprising the steps of:
disposing an electrothermal deicing element at a surface of an airfoil; and
disposing a layer of dielectric material comprising a filler of magnetic material over the electrothermal deicing element.

16. The method of claim 15 including the step of tuning the frequency range of radar absorption by controlling the amount of magnetic filler material disposed in the layer of dielectric material.

17. The method of claim 15 including the step of mixing the magnetic filler material into the dielectric material and forming the dielectric layer filled with magnetic material by a roller milling process.

18. The method of claim 15 including the step of controlling the thickness of the dielectric layer to effect both radar absorption and electrothermal deicing.

19. The method of claim 15 wherein the electrothermal deicing element and layer of dielectric material are disposed within an airfoil of composite material.

20. The method of claim 19 wherein the electrothermal deicing element and layer of dielectric material are disposed at the surface of the airfoil of composite material.
